(19) United States
(12) Patent Application Publication
(10) Pub. No.: US 2007/0023690 A1
(43) Pub. Date: Feb. 1, 2007

(54) Method of producing heat-resistant electrically charged fluororesin material and method of producing electret condenser microphone using heat-resistant electrically charged fluororesin material

(76) Inventors: Yuki Tsuchiya, Fujiyoshida-shi (JP); Keiji Watanabe, Fujiyoshida-shi (JP); Yorinobu Yamada, Fujiyoshida-shi (JP)

Correspondence Address: BRINKS HOFER GILSON & LIONE, P.O. BOX 10395, CHICAGO, IL, 60610, US

(21) Appl. No.: 11/479,804

(22) Filed: Jun. 30, 2006

(30) Foreign Application Priority Data
Jul. 1, 2005 (JP) JP2005-193231
Jul. 4, 2005 (JP) JP2005-194478

(51) Int. Cl. B05D 3/00; B29C 71/02; B05D 3/02

(52) U.S. Cl. 250/492.1; 427/532; 427/372.2

(57) ABSTRACT

A method of producing a heat-resistant electrically charged fluororesin material is provided. The method comprises the steps of providing a fluorine-containing resin material; irradiating the fluorine-containing resin material with ionizing radiation at a temperature not lower than a crystalline melting point of the fluorine-containing resin material in absence of oxygen, thereby causing crosslinking in the fluorine-containing resin material to change the fluorine-containing resin material into a heat-resistant fluororesin material; and, electrifying the heat-resistant fluororesin material to form a heat-resistant electrically charged fluororesin material. The method may further comprises the step of heating the material following the step of electrifying. The successive steps of electrifying and heating are repeatedly conducted more than one time.

This application claims priority under 35 U.S.C. § 119 to Japanese Patent Application Nos. JP2005-193231 filed Jul. 1, 2005 and JP2005-194478 filed Jul. 4, 2005, the entire content of which is hereby incorporated by reference.

### FIELD OF INVENTION

The present invention relates to a method of producing a heat-resistant electrically charged fluororesin material and a method of producing an electret condenser microphone using the heat-resistant electrically charged fluororesin material forming an electret.

### DESCRIPTION OF THE RELATED ART

An electret condenser microphone, for example, is known as an electrical product using a charged resin material.

A conventional electret condenser microphone is disclosed, for example, in Japanese Patent Application Publication No. 2002-345087. The electret condenser microphone has a diaphragm and an electret layer that are opposed to each other. The electret layer is formed by permanently electrifying (electrically charging) a resin layer formed on a metal backplate substrate. The electret may be formed on a backplate electrode formed on a resin or ceramic backplate substrate.

When the electret condenser microphone is adopted in a household device, it is soldered on a circuit board (motherboard) of the device on which other electronic elements are mounted. It is desirable from the viewpoint of packaging cost that the electret condenser microphone be surface-mountable on the motherboard. To perform surface mounting, however, the electret condenser microphone needs to be placed on the motherboard and put into a reflow oven, in which it is subject to preheating at about 150° C. to 200° C. for 90 to 120 seconds, and then heated at a high temperature of 230° C. to 260° C. for 100 seconds. Under discharge or decay, so that the electret condenser microphone becomes unable to perform its function as a microphone.

Some propositions have heretofore been made to solve the above-described problem. For example, Published Japanese Translation for PCT International Publication for Patent Application No. 2001-518246 discloses an electret condenser microphone that uses silicon, i.e. an inorganic material, as an electret material in place of an organic resin material, which is problematic in terms of heat resistance. The electret made of silicon is free from the problem of heat resistance and allows surface mounting of an electret condenser microphone in a reflow oven. However, this electret is expensive.

Japanese Patent Application Publication No. 2000-32596 discloses a method of producing a high heat-resistant electret condenser microphone. According to the disclosed method, a backplate substrate is prepared by fusion-bonding a resin material for constituting an electret layer to a metal substrate. The backplate substrate is subject to high-temperature annealing at about 200° C. for about 1 to 6 hours and then to electric charge implantation, thereby forming an electret.

Meanwhile, Japanese Patent No. 3317452 discloses a heat-resistant fluororesin, although this is not directly concerned with an electret condenser microphone. According to the invention of this patent, a fluorine-containing resin material, e.g. polytetrafluoroethylene (hereinafter abbreviated as “PTFE), fluorinated ethylene-propylene copolymer or tetrafluoroethylene hexafluoropropylene copolymer (hereinafter abbreviated as “FEP”), or tetrafluoroethylene-perfluoroalkyl vinyl ether copolymer (hereinafter abbreviated as “PFA”), is irradiated with a predetermined dose of ionizing radiation at a temperature not lower than the crystalline melting point of the resin material in the absence of oxygen, thereby changing into a crosslinked modified fluororesin. Further, Japanese Patent Application Publication No. 11-49867 discloses a crosslinked modified fluororesin produced by irradiating FEP with a predetermined dose of ionizing radiation at a temperature in the neighborhood of the crystalline melting point of the FEP in the absence of oxygen.

These techniques concerning the heat-resistant fluororesin were developed to improve fluororesin, which cannot be used under radiation environment, e.g. in nuclear power facilities as it has a radiation—degradable molecular structure while it is excellent in heat resistance and chemical resistance and widely used for industrial and household purposes. According to these techniques, fluororesin is irradiated with ionizing radiation to effect crosslinking, thereby markedly improving heat resistance and mechanical properties under radiation environment.

### SUMMARY OF THE INVENTION

We took notice of the crosslinked modified fluororesin disclosed in Japanese Patent No. 3317452 and Japanese Patent Application Publication No. H11-49867.

That is, in view of the fact that the crosslinked modified fluororesin exhibits high heat-resistant characteristics under adverse environment, e.g. radiation environment, we assumed that if a charged resin material obtained by electrically charging the modified fluororesin is used as an electret layer, the decay of the electric charge of the electret layer under the reflow conditions can be effectively prevented.

According to one aspect of the present invention, there is provided a method of producing a heat-resistant electrically charged fluororesin material, comprising the steps of:

providing a fluorine-containing resin material;

forming an adhesive layer on a side of the material;

irradiating the fluorine-containing resin material with ionizing radiation at a temperature not lower than a crystalline melting point of the fluorine-containing resin material in absence of oxygen, thereby causing crosslinking in the fluorine-containing resin material to change the fluorine-containing resin material into a heat-resistant fluororesin material; and,

electrifying the heat-resistant fluororesin material to form a heat-resistant electrically charged fluororesin material;

wherein the adhesive layer acts on the fluorine-containing resin material to maintain the shape of the material during the steps of irradiating and electrifying.

As stated in the description of embodiments of the present invention below, it has been proved that the heat-resistant fluororesin material can be stably electrified by the adhesive layer which acts on the fluorine-containing resin material to keep the shape of the material during the step of irradiating and the step of electrifying. It can therefore be said that the adhesive in the present invention may be any kind of adhesives that will not be shrunken at a high temperature, to which the fluorine-containing resin material is subject during processes for producing the heat-resistant fluororesin material so that the adhesive can maintain the shape of the fluorine-containing material. For example, the adhesive may be an acrylic adhesive, a silicone adhesive, an epoxy pressure-sensitive adhesive, a silicone pressure-sensitive adhesive, a thermosetting-type adhesive, an ultraviolet-setting type adhesive, although in the embodiment explained below an acrylic pressure sensitive adhesive is used.

Preferably, the method further comprises the step of heating the fluorine-containing resin material with the adhesive layer at a temperature not lower than a crystalline melting point of the fluorine-containing resin material in presence of oxygen before the step of irradiating. The heating step will promote the set of the adhesive set without shrinkage thereof.

Further, it is prefereable that, before the step of heating, the fluorine-containing resin material is adhered to a substrate through the adhesive layer.

The substrate may be one selected from a group consisting of a metal substrate, a resin substrate, and a ceramic substrate.

The step of heating may be performed at a temperature of 260° C. to 330° C. in the air.

Further, in the step of irradiating, the fluorine-containing material may be irradiated with ionizing radiation at a dose of 10 kGy to 100 kGy, at a temperature of 260° C. to 330° C., and at an oxygen concentration not higher than 50 ppm.

The fluorine-containing resin material may be one selected from the group consisting of polytetrafluoroethylene, tetrafluoroethylene-hexafluoropropylene-copolymer, and tetrafluoroethylene-perfluoroalkyl-vinyl-ether-copolymer.

The method may further comprise a step of heating the heat-resistant fluororesin material following the step of electrifying, wherein the successive steps of electrifying and heating are repeatedly effected more than one time. As stated in the description of the embodiments, it has been proved that the repetition of the successive steps greatly increase the quantity of electric charge of the heat-resist fluororesin material.

The fluorine-containing resin material may be in the shape of a sheet.

The heat-resistant electrically charged fluororesin material may be negatively electrified.

According to another aspect of the present invention, there is provided a method of producing a heat-resistant electrically charged fluororesin material, comprising the steps of:

providing a fluorine-containing resin material;

irradiating the fluorine-containing resin material with ionizing radiation at a temperature not lower than a crystalline melting point of the fluorine-containing resin material in absence of oxygen, thereby causing crosslinking of the fluorine-containing resin material to change the fluorine-containing resin material into a heat-resistant fluororesin material;

electrifying the heat-resistant fluororesin material; and

heating the heat-resistant fluororesin material following the step of electrifying;

wherein the successive steps of electrifying and heating are repeatedly effected more than one time.

In this method, the fluorine-containing resin material may be in the shape of a sheet.

Further, the heat-resistant electrically charged fluororesin material may be negatively electrified.

Further, in this method, the step of electrifying may be performed by a corona discharge of a voltage of −500 V +/−200 V at an ambient temperature in the air; and, the step of heating the heat-resistant fluororesin material is performed at a temperature of 260° C. to 330° C. In the step of irradiating, the fluorine-containing material may be irradiated with ionizing radiation at a dose of 10 kGy to 100 kGy, at a temperature of 260° C. to 330° C., and at an oxygen concentration not higher than 50 ppm.

According to an aspect of the present invention, there is provided an electret condenser microphone comprising a diaphragm and an electret layer opposed to the diaphragm, wherein the electret layer is made of a heat-resistant electrically charged fluororesin material produced by the above stated method.

According to an another aspect of the present invention, there is provided a method of producing an electret condenser microphone comprising a diaphragm and an electret layer formed on a backplate substrate. The method comprises the steps of:

preparing a backplate substrate having a flat surface;

preparing a sheet-shaped member of fluorine-containing resin material having opposite sides;

forming an adhesive layer on one of the opposite sides of the sheet-shaped member;

adhering the sheet-shaped member on the flat surface of the backplate substrate through the adhesive layer;

irradiating the fluorine-containing resin material with ionizing radiation at a temperature not lower than a crystalline melting point of the fluorine-containing resin material, thereby causing crosslinking in the fluorine-containing resin material to change the fluorine-containing resin material into a heat-resistant fluororesin material; and,

electrifying the heat-resistant fluororesin material to change the heat-resistant fluororesin material into an electret layer on the backplate substrate;

wherein the adhesive layer acts on the sheet-shaped member to maintain the shape of the sheet-shaped member during the steps of irradiating and electrifying.

This method may further comprises the step of heating the fluorine-containing resin material with the adhesive layer at a temperature not lower than a crystalline melting point of the fluorine-containing resin material in presence of oxygen before the step of irradiating.

According to a further aspect of the present invention, there is provided a method of producing electret condenser microphones each comprising a diaphragm, an electret layer formed on a backplate substrate, a spacer interposed between the diaphragm and the electret layer, and electronic circuit board on which the backplate substrate is disposed. The method comprises the steps of:

providing an electronic circuit board assembly in which a multiplicity of electronic circuit boards comprising electronic elements mounted thereon are arrayed in a matrix;

providing a backplate substrate assembly in which a multiplicity of backplate substrates each having a flat surface are arrayed in a matrix;

providing sheet-shaped members of fluorine-containing resin material, each of the sheet-shaped members having opposite sides;

providing a spacer assembly in which a multiplicity of spacers are arranged in a matrix;

providing a diaphragm assembly in which a multiplicity of diaphragm units are arrayed in a matrix;

forming an adhesive layer on one side of each sheet-shaped member;

adhering the sheet-shaped members onto the flat surfaces of the backplate substrates through the adhesive layers, respectively;

irradiating the sheet-shaped members with ionizing radiation at a temperature not lower than a crystalline melting point of the fluorine-containing resin material, thereby causing crosslinking in the fluorine-containing resin material to change the fluorine-containing resin material into a heat-resistant fluororesin material; and,

electrifying the sheet-shaped members to change them into electret layers;

securely stacking the electronic circuit board assembly, the backplate substrate assembly, the spacer assembly and the diaphragm assembly to form a stacked assembly; and

cutting the stacked assembly into individual electret condenser microphones;

wherein the adhesive layers act on the sheet-shaped members to maintain the shape of the sheet-shaped members during the steps of irradiating and electrifying.

This method may, further comprising the step of heating the fluorine-containing resin material with the adhesive layer at a temperature not lower than a crystalline melting point of the fluorine-containing resin material in presence of oxygen before the step of irradiating.

According to a different aspect of the present invention, there is provided a method of producing electret condenser microphones each comprising a diaphragm, an electret layer formed on a flat surface of a backplate substrate, a spacer interposed between the diaphragm and the electret layer, and electronic circuit board on which the backplate substrate is disposed, the method comprising the steps of:

providing an electronic circuit board assembly in which a multiplicity of electronic circuit boards comprising electronic elements mounted thereon are arrayed in a matrix;

providing a backplate substrate assembly in which a multiplicity of backplate substrates are arrayed in a matrix;

providing a sheet-shaped member of fluorine-containing resin material having an adhesive layer provided on one side of the sheet-shaped member;

providing a spacer assembly in which a multiplicity of spacers are arranged in a matrix;

providing a diaphragm assembly in which a multiplicity of diaphragm units are arrayed in a matrix;

irradiating the sheet-shaped member with ionizing radiation in absence of oxygen at a temperature not lower than a crystalline melting point of the fluorine-containing resin material, thereby causing crosslinking in the fluorine-containing resin material to change the fluorine-containing resin material to heat-resistant fluororesin material;

stamping the sheet-shaped member to form a multiplicity of pieces of the sheet-shaped member with pieces of the adhesive layer;

securely attaching the pieces of the sheet-shaped member to the flat surfaces of the backplate substrate through the pieces of the adhesive layer, respectively;

electrifying the pieces of the sheet-shaped member to change them to electret layers on the backplate substrates;

securely stacking the electronic circuit board assembly, the backplate substrate assembly, the spacer assembly and the diaphragm assembly to form a stacked assembly; and

cutting the stacked assembly into individual electret condenser microphones;

wherein the pieces of the adhesive layer act on the pieces of the sheet-shaped members to maintain the shape of the pieces of the sheet shaped members during the steps of irradiating and electrifying.

This method may further comprises the steps of:

heating the sheet-shaped member in presence of oxygen at a temperature not lower than a crystalline melting point of the fluorine-containing resin material before the step of irradiating the sheet-shaped member; and,

heating the pieces of the sheet-shaped members succeeding to the step of electrifying;

wherein the successive steps of irradiating and heating the sheet-shaped member is repeatedly effected more than one time.

According to a further aspect of the present invention, there is provided a method of producing an electret condenser microphone comprising a diaphragm and an electret layer formed on a backplate substrate; the method comprising the steps of:

providing a backplate substrate having a flat surface disposed thereon;

providing a sheet-shaped member of fluorine-containing resin material;

securely disposing the sheet-shaped member on the flat surface of the backplate substrate;

irradiating the sheet-shaped member on the backplate substrate with ionizing radiation at a temperature not lower than a crystalline melting point of the fluorine-containing resin material in absence of oxygen, thereby causing crosslinking of the fluorine-containing resin material to change the fluorine-containing resin material into a heat-resistant fluororesin material;

electrifying the heat-resistant fluororesin material; and

heating the sheet-shaped member following the step of electrifying;

wherein the successive steps of electrifying and heating are repeatedly effected more than one time to change the sheet-shaped member into an electret layer on the backplate substrate.

According to an aspect of the present invention, there is provided a method of producing electret condenser microphones each comprising a diaphragm, an electret layer formed on a backplate substrate, a spacer interposed between the diaphragm and a flat surface of the backplate substrate to surround the electret layer, and electronic circuit board on which the backplate substrate is disposed, the method comprising the steps of:

providing an electronic circuit board assembly in which a multiplicity of electronic circuit boards comprising electronic elements mounted thereon are arrayed in a matrix;

providing a backplate substrate assembly in which a multiplicity of backplate substrates each having a flat surface are arrayed in a matrix;

providing sheet-shaped members of fluorine-containing resin material, each sheet-shaped member having opposite sides;

providing a spacer assembly in which a multiplicity of spacers are arranged in a matrix;

providing a diaphragm assembly in which a multiplicity of diaphragm units are arrayed in a matrix;

securely disposing the sheet-shaped member on the flat surfaces of the backplate substrates, respectively;

irradiating the sheet-shaped members on the backplate substrates with ionizing radiation at a temperature not lower than a crystalline melting point of the fluorine-containing resin material, thereby causing crosslinking of the fluorine-containing resin material to change the fluorine-containing resin material to heat-resistant fluororesin material; and,

electrifying and successively heating the sheet-shaped members after the step of irradiating more than one time to form an electret on the backplate substrates;

securely stacking the electronic circuit board assembly, the backplate substrate assembly, the spacer assembly and the diaphragm assembly to form a stacked assembly; and

cutting the stacked assembly into individual electret condenser microphones.

Embodiments of the present invention will be explained below with reference to the accompanying drawings.

### BRIEF DESCRIPTION OF THE DRAWINGS

FIG. 1 is a process flow chart showing a method of producing a heat-resistant electrically charged fluororesin material according to the present invention.

FIG. 2 is a sectional view of a sheet-shaped fluorine containing resin with an adhesive layer prepared in a first step of the method shown in FIG. 1.

FIG. 3 is a sectional view of the sheet-shaped fluorine containing resin with a substrate being attached thereto through the adhesive layer.

FIG. 4 is a comparison characteristic chart showing heat-resistant characteristics of heat-resistant electrically charged fluororesin materials produced by the method of the present invention.

FIG. 5 is a comparison characteristic chart showing heat-resistant characteristics of heat-resistant electrically charged fluororesin materials produced by the method of the present invention and electrically charged fluororesin materials produced by a conventional method.

FIGS. 6 (a) and 6 (b) show a fluorine containing material with a substrate being attached thereto by acrylic adhesive; the upper half showing a plan view and a cross-sectional side elevation view of the material before being subject to the EB treatment, which will be explained later, in the left and in the right, respectively, and the lower half showing a plan view and a side elevation view of the material after being subject to the EB treatment in left and in the right, respectively.

FIGS. 7 (a) and 7(b) show a fluorine containing material with a substrate being attached thereto by rubber adhesive; the upper half showing a plan view and a side elevation view of the material before being subject to a EB treatment in the left and in the right, respectively, and the lower half showing a plan view and a side elevation view of the material after being subject to the EB treatment in left and in the right, respectively.

FIG. 8 is an sectional view of an electret condenser microphone comprising an electret layer made of a heat-resistant electrically charged fluororesin produced by the method of the present invention.

FIG. 9 is an exploded perspective view of the electret condenser microphone shown in FIG. 8.

FIG. 10 is an exploded perspective view of assemblies containing constituent elements used in an electret condenser microphone producing method according to the present invention.

FIG. 11 is a perspective view of the electret condenser microphone assembly formed by securely stacking the assemblies containing constituent elements shown in FIG. 10.

FIG. 12 is a perspective view of individual electret condenser microphones formed by cutting the microphone assembly shown in FIG. 11.

FIG. 13 is a process flow chart of the electret condenser microphone producing method of the present invention.

### DETAILED DESCRIPTION OF THE PREFERRED EMBODIMENTS

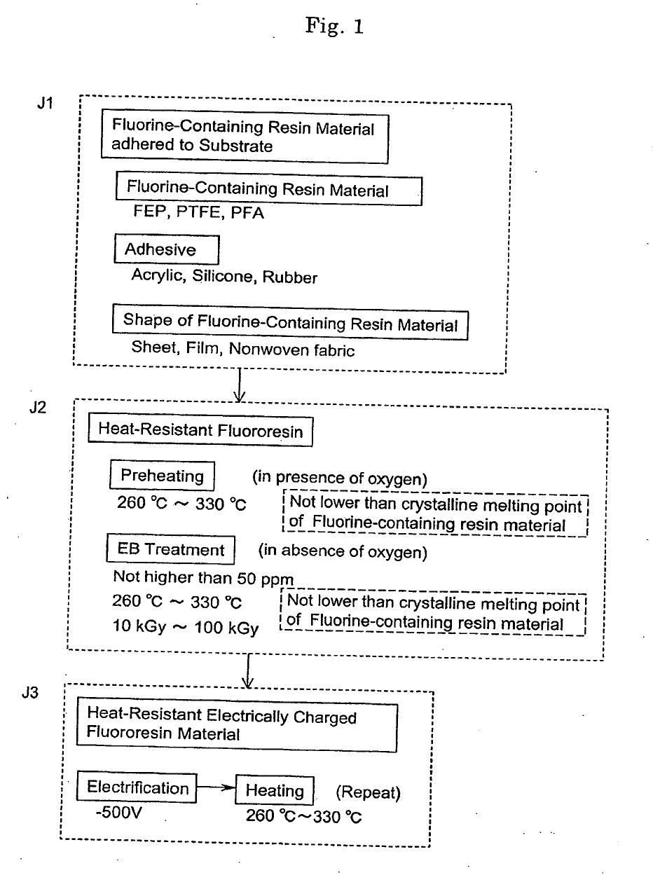

FIG. 1 is a process flow chart showing the steps of a method of producing a heat-resistant electrically charged fluororesin material according to an embodiment of the present invention. The method comprises steps J1, J2 and J3.

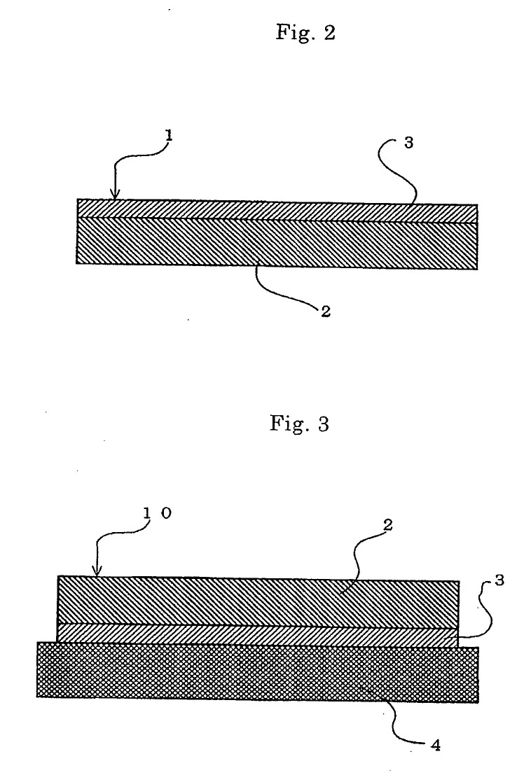

In step J1, a sheet-shaped member 2 of fluorine-containing resin material such as FEP, PTFE, and PFA is prepared and, as shown in FIG. 2, applied with an adhesive 3. The sheet-shaped member 2 is then, as shown in FIG. 3, attached to a substrate 4 through the pressure-sensitive adhesive 3. The adhesive may be in the form of a sheet or liquid and preferably an acrylic adhesive, a silicone adhesive, or the like. The substrate may be made of metal, resin or ceramic etc.

The sheet-shaped member 2 has a thickness of, for example, 12.5 μm or 25 μm and one of the opposite surfaces of the sheet member 2 is subject to a corona discharge to make the surface activated. On the activated surface, a liquid acrylic adhesive is applied with thickness of, for example, 3 μm. The sheet-shaped member is then pressed and adhered to a side of the substrate at a temperature of, for example, around 150° C.

In step J2, the sheet-shaped member 2 of fluorine-containing resin material with the substrate 4 is heated and irradiated with ionizing radiation or electron beam to change it into a crosslinked heat-resistant fluororesin member.

Specifically, the sheet-shaped member 2 with the substrate 4 is preheated in an atmosphere at a temperature of 260° C. to 330° C., which is not lower than the crystalline melting point of the fluorine-containing resin material for a predetermined time, for example, 5 minutes. During the preheating treatment, the adhesive 3 is set or become hard. Following the preheating treatment, the sheet-shaped member 2 is irradiated with ionizing radiation, for example, at a dose of 10 kGy to 100 kGy with an electron beam intensity of 500 keV to 800 keV at a temperature of 260° C. to 330° C., which is not lower than the crystalline melting point of the fluorine-containing resin material, at an oxygen concentration not higher than 50 ppm. In this specification, the irradiation process under conditions such as stated above is referred to as “EB treatment”. By the EB treatment, a crosslinking reaction of the melted fluorine-containing resin material is performed to change the fluorine-containing resin material into a heat-resistant fluororesin material.

In step J3, the sheet-shaped member 2 of the crosslinked heat-resistant fluororesin material with the substrate 4 is subject to electric charge implantation by effecting corona discharge at an ambient temperature to change the crosslinked heat-resistant fluororesin material to a heat-resistant electrically charged resin material.

Table 1 below shows a result of a heat-resistant test conducted on samples or sheet-shaped members which were produced through steps J1-J3 as stated above, wherein the fluorine containing resin material was FEP and the adhesive was an acrylic pressure-sensitive adhesive.

The samples A1 to C3 of the sheet-shaped member of FEP were irradiated with ionizing radiation at 3 different temperatures, i.e. 260° C., 280° C. and 300° C. and at 3 different levels of radiation irradiation dose, i.e. 10 kGy, 50 kGy and 100 kGy. The above different temperatures were adapted in light of typical temperatures in a reflow furnace. As mentioned above, the temperature may be set at from 260° C. to 330° C. However, in view of manufacturing a microphone, the conditions of the temperature were determined to be not higher than 300° C., as FEP may be softened and deformed at a temperature higher than 300° C. There is shown, for comparison, a sample D or a sheet-shaped member with the substrate which was not subjected to the process of step J2.

The charge residual ratio (%) shown in Table 1 below was calculated as follows. Each sample was placed on a hot plate at 200° C., and the surface potential was measured at one minute intervals from the initiation of heating until 5 minutes elapsed in view of the time period during which the electret layer is exposed to such a high temperature during reflow process, i.e. from 2 to 3 minutes. In addition, assuming more severe conditions, we calculated the charge residual ratio when 10 minutes had elapsed from the initiation of the heating. The charge residual ratio was calculated on the basis of the measured surface potential and the initial surface potential.

TABLE 1

| Conditions in | | | | | | | | | |
|---|---|---|---|---|---|---|---|---|---|
| step J2 | | Charge residual ratio (%) | | | | | | | |
| Temp. | Dose | | | | | | | 10 | Sam- |
| [° C.] | [kGy] | Initial | 1 min | 2 min | 3 min | 4 min | 5 min | min | ple |
| 260 | 10 | 100.0 | 79.1 | 68.5 | 62.1 | 54.9 | 51.3 | 39.7 | A1 |
| | 50 | 100.0 | 72.4 | 55.8 | 49.2 | 45.9 | 42.4 | 31.1 | A2 |
| | 100 | 100.0 | 66.2 | 53.0 | 46.5 | 38.3 | 36.6 | 21.8 | A3 |
| 280 | 10 | 100.0 | 84.5 | 80.3 | 74.1 | 70.9 | 68.7 | 58.9 | B1 |
| | 50 | 100.0 | 86.9 | 79.0 | 74.5 | 71.4 | 68.3 | 57.2 | B2 |
| | 100 | 100.0 | 89.6 | 86.3 | 83.8 | 78.4 | 74.9 | 63.1 | B3 |
| 300 | 10 | 100.0 | 92.5 | 90.4 | 88.4 | 86.0 | 84.2 | 78.3 | C1 |
| | 50 | 100.0 | 92.0 | 89.8 | 87.4 | 85.3 | 84.0 | 76.9 | C2 |
| | 100 | 100.0 | 91.6 | 87.1 | 82.0 | 78.1 | 75.6 | 66.8 | C3 |

| | | | | |
|---|---|---|---|---|
| Unprocessed | 100.0 | 23.1 | 9.9 | D |

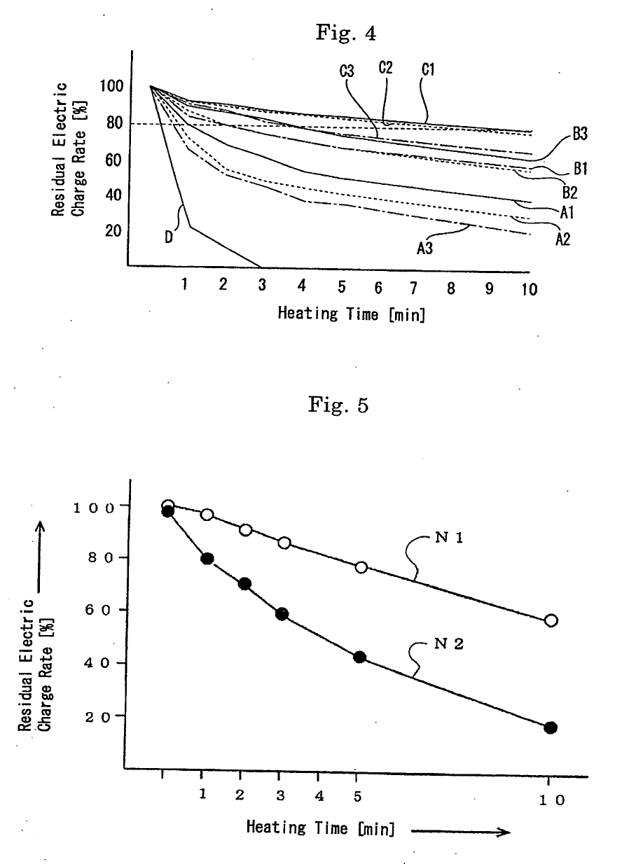

FIG. 4 is a comparison characteristic chart showing the results of the test shown in Table 1. As noted from Table 1 and FIG. 4, the charge residual ratio of the sample, which was not subject to the process of step J2, reduced to about ¼ at an elapsed time of 1 minute after the initiation of the heating, to about 1/10 at an elapsed time of 2 minutes and to zero at an elapsed time of 3 minutes. In contrast, all the samples, A1-C3, which were subject to the processes of step J2 treatment, kept the electric charge in even when 10 minutes had elapsed. Thus, it is clear that the EB treatment in step J2 is effective in allowing the electric charge to remain in the samples.

Let us compare the effect of radiation irradiation for each irradiation condition. Regarding the temperature condition, it will be understood that the samples C, which were heated to 300° C., are the best; the samples B, which were heated to 280° C., are the second best; and the samples A, which were heated to 260° C., are the third best. Regarding the irradiation dose, it will be understood that, although the samples B show somewhat different results, 10 kGy is the best for the samples A and C, and 50 kGy is the second best but fairly good, and that 100 kGy is the third best and slightly inferior to 10 kGy and 50 kGy.

In view of the above-described reflow temperature, the samples C1 and C2 are the best, and the samples C3 and B3 are the second best. That is, these samples exhibit a charge residual ratio of 80% or more after elapse of 2 to 3 minutes, which is considered to be a time period during which the electret layer is exposed to high temperature during reflow process. The sample B3, however, may be ignored because it tends to show somewhat abnormal values. Thus, it will be understood that a temperature of 300° C. and an irradiation dose of 10 kGy to 50 kGy are particularly suitable as radiation irradiation conditions. If consideration is given to the performance expected for the electret condenser microphone and the allowance for deformation of the electret layer, however, the electret layer may be irradiated with ionizing radiation at a temperature of 280° C. to 330° C. and an irradiation dose of 10 kGy to 100 kGy.

Further, each sample was subject to a humidity resistance test under an environment of 60° C. and 95% in humidity. For all the samples, the charge residual ratio after they had been allowed to stand for 60 hours was 95% to 97%, and the charge residual ratio after the samples had been allowed to stand for 300 hours was 93% to 95%. Thus, there was no problem in terms of humidity resistance.

With regard to the results of the above stated tests, it is presumed that since the adhesive is set or solidified by the preheating treatment in step J2 and further the fluororesin material is modified by the crosslinking reaction, it is difficult for molecules of the fluororesin material to move even if the fluororesin material is heated after the set or solidification of the adhesive and the crosslinking reaction. When the so-modified or heat-resistant fluororesin material is therefore subject to the electric charge implantation in step J3, the electric charge is stably retained in the heat-resistant fluororesin material.

Although FEP was used as a fluorine-containing resin material in the above stated tests, the same results were obtained also for PTFE and PFA.

FIG. 5 is a comparison chart showing time series of the electric charge residual ratios in the sheet-shaped member with the substrate as shown in FIG. 3, wherein FEP was used as the fluorine containing resin material and an acrylic pressure-sensitive adhesive was used to adhere the sheet-shaped member to the substrate, and the sheet-shaped member without the substrate, both of the sheet-shaped members having been subject to steps J2 and J3 stated above. To calculate the electric charge residual ratios, those sheet-shaped members were placed on a hot plate at a temperature of 200° C., and the surface potentials thereof were measured at one minute intervals from the initiation of the heating until the heating time of 5 minutes elapsed in view of the time period during which the electret layer is exposed to high temperature during reflow process, i.e. from 2 to 3 minutes. In addition, assuming more strict conditions, the charge residual ratio was measured when 10 minutes had elapsed from the initiation of the heating. As shown in FIG. 5, the residual ratio of electric charge in the sheet-shaped member without the substrate, which is denoted by sample symbol N2, decreased to 80% at an elapsed time of 1 minute after the initiation of the heating, to 70% at elapsed time of 2 minutes, to 45% at elapsed time of 5 minutes and to 20% at elapsed time of 10 minutes. In contrast, the electric charge residual ratio in the sheet-shaped member with the substrate prepared through the steps J1-J3 of the method according to the present invention, which is denoted by sample symbol N1, decreased to 80% at an elapsed time of 5 minutes after the initiation of the heating and to 65% at an elapsed time of 10 minutes. Thus, it is clear that adhering of the sheet-shaped member to the substrate is effective in allowing the electric charge implanted thereto in step J3 to remain therein. However, it should be noted that the sample N2 has a high electric charge residual ratio as compared with the sample D in FIG. 4 which was not subject to step J2.

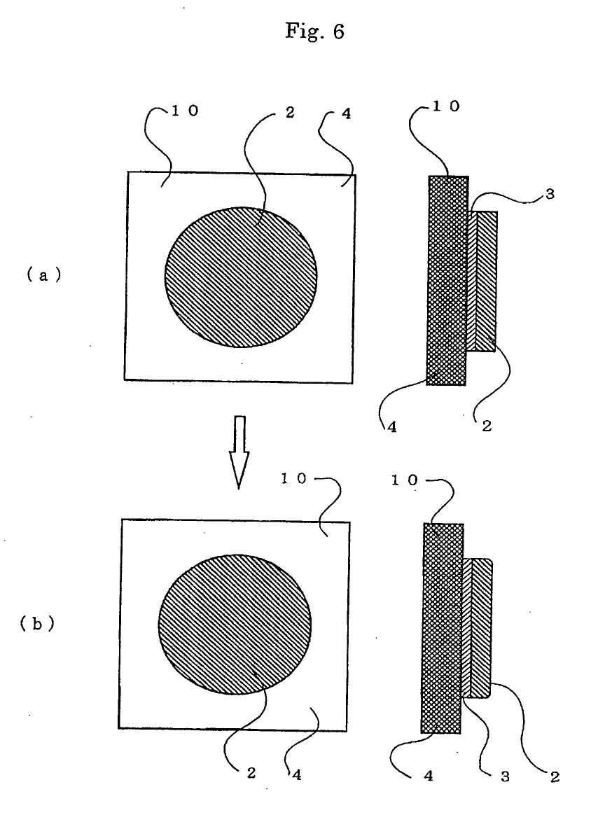

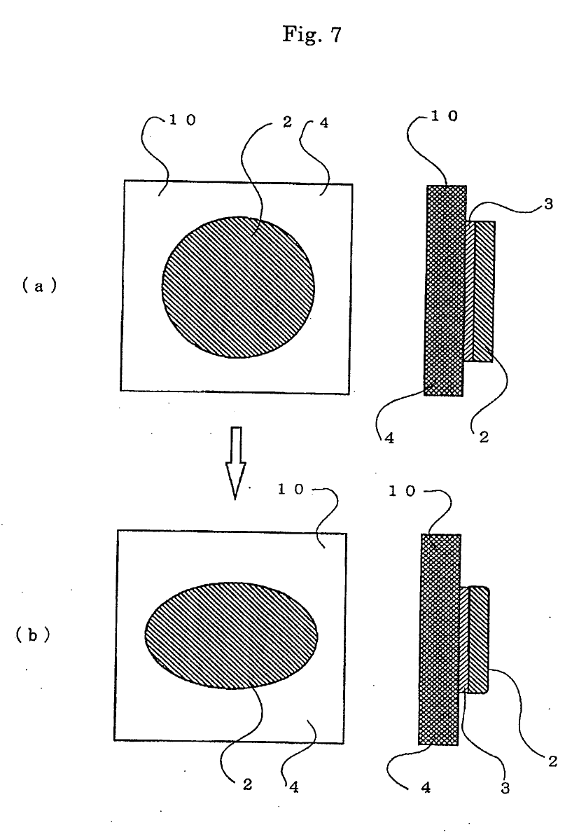

FIG. 6 shows the sheet-shaped member 2 of FEP with the substrate 4 being attached thereto by acrylic pressure-adhesive adhesive, the upper half part thereof showing a plan view and a cross-sectional side elevation view of the sheet-shaped member before being subject to the EB treatment in the left and in the right, respectively, and the lower half part thereof showing a plan view and a cross-sectional side elevation view of the sheet-shaped member after being subject to the EB treatment in left and in the right, respectively. FIG. 7 shows views similar to those of FIG. 6 wherein the adhesive used to adhere the sheet-shaped member 2 to the substrate 4 was a rubber adhesive.

It is noted that FIG. 6 shows that there was no substantial change in shape of the sheet-shaped member, which is, as viewed in the plan view, circular, whereas FIG. 7 shows that the adhesive 3 was shrunken to the extent that the shape of the sheet-shaped member was changed from a circle to an oval as viewed in the plan view.

Further, it has been found that the sheet-shaped member of FIG. 7 has poor charge residual ratio properties, whereas the sheet-shaped member of FIG. 6 has, as discussed above, good charge residual ratio properties. It is therefore needed that when a rubber adhesive is used, any means be provided to prevent the shrinkage of the rubber adhesive. In other words, the adhesive can be any kind of adhesives that act on the sheet-shaped member to maintain the shape of the member during the step J2. Specifically, in place of the acrylic pressure-sensitive adhesive, a silicone pressure adhesive, a thermosetting-type adhesive, an ultraviolet-setting adhesive or the like can be used.

It has been proved that a silicon adhesive is not shrunken under the high temperature in step J2 and can be used in place of the acrylic adhesive.

In the above tests, the electric charge implantation in step J3 is performed only once at a room temperature in the atmosphere. It has been proved out that the quantity of electric charge can be increases by repeating the process of electric charge implantation followed by heating.

Table 2 below shows quantities of electric charge retained in samples S1-S10 or the sheet-shaped members which went through steps J1 and J2, wherein step J2 was effected at a temperature of 300° C. and at different levels of radiation irradiation dose, i.e., 10 kGy, 15 kGy and 50 kGy, and thereafter were subject to the process of electric charge implantation followed by heating stated above one through fifteen times. The electric charge implantation was conducted by means of corona discharge at −500 V in the atmosphere and the following heating was effected at 285° C. +/−25° C. for about 10 seconds. In Table 2, the quantities of electric charge retained in the samples are represented by absolute values of surface potentials of the samples which were measured as negative voltages.

TABLE 2

| | Quantities of electric charge (−V) (Electric charge | | | | | | | | | | |
|---|---|---|---|---|---|---|---|---|---|---|---|
| | implantation-heating repeat frequency) | | | | | | | | | | |
| Samples | 1st | 2nd | 3rd | 4th | 5th | 6th | 7th | 8th | 9th | 10th | 15th |
| S1 | 82 | 98 | 87 | 87 | 132 | 140 | 136 | 130 | 127 | 125 | 120 |
| S2 | 57 | 79 | 76 | 80 | 98 | 116 | 118 | 110 | 109 | 102 | 96 |
| S3 | 65 | 84 | 89 | 108 | 143 | 160 | 156 | 147 | 141 | 140 | 132 |
| S4 | 73 | 89 | 84 | 108 | 141 | 153 | 153 | 148 | 134 | 138 | 125 |
| S5 | 64 | 83 | 85 | 88 | 119 | 127 | 129 | 130 | 128 | 98 | 90 |
| S6 | 90 | 90 | 105 | 121 | 149 | 164 | 157 | 151 | 142 | 141 | 137 |
| S7 | 57 | 89 | 99 | 119 | 135 | 144 | 148 | 138 | 135 | 128 | 124 |
| S8 | 64 | 88 | 98 | 113 | 128 | 142 | 144 | 136 | 132 | 113 | 107 |
| S9 | 62 | 61 | 74 | 96 | 105 | 106 | 106 | 106 | 105 | 88 | 85 |
| S10 | 63 | 77 | 60 | 85 | 93 | 106 | 104 | 100 | 102 | 94 | 91 |
| Average | 67.6 | 83.8 | 85.7 | 100.5 | 124.3 | 135.8 | 135.1 | 129.6 | 125.5 | 116.7 | 110.7 |

As shown in Table 2, the mean of the voltages which were measured on samples S1-S10 after the first process was −67.6 V which was almost the same as that without the process.

The mean of the voltages after the second process was −83.8 V, −85.7 V after the third process, −100.5 V after the fourth process, −124.3 V after the fifth process and −135.8 V after the sixth process whose absolute value reaches maximum. Thereafter, the absolute value of the mean of the measured voltages slightly and gradually decrease, that is, −135.1 V after the 7th process, −129.6 V after the 8th process, −125.5 V after the 9th process, −116.7 V after 10th process and −110.7 V after 15the process, whose absolute values were retained not less than 100 V.

Thus, it is clear that good effects are gained after 4 or more times of repetition of the process. Although the size and shape of the heat-resistant fluororesin material are considered to influence the effects of the repetition of the process, it is desirable that the process be repeated 4 or more times in order to gain good effects.

Table 2 shows that some samples such as samples S3 and S6 show high electric charge retention and other samples such as samples S2 and S3 show low electric charge retention. This is considered to be caused by difference in size of FEP and/or the conditions of adhesive to the substrate. It should be noted, however, that the trend of the change in the quantities of electric charge of the samples after being subject to repetition of the process is the same among all samples.

The following is an explanation of the relationship between the quantities of electric charge retention and the repetition of the process of electric charge implantation and followed by heating

The electric charge implantation in a heat-resistant fluororesin material will take place in a portion where it is difficult for molecules to move, e.g., a crosslinked portion or a microcrystallized portion wherein the interaction between molecules is strong.

Further, the portion where molecules can not easily move may be imaged as a deep quantum well. The electrons fall into the quantum well, so that the electrons are stably retained therein to generate negative electric charge.

When the heat-resistant fluororesin material is heated under the condition that the material has the negative electric charge, the microcrystallized portion or the like increases so that the electric charge retention properties is improved.

This will be able to be explained that the quantum wells in the material will be made deeper by heating of the material when the wells hold electrons therein than that when the well holds little of electrons, thereby enabling the deepened wells to stably receive more electrons.

The data of processes after the 6th in Table 2 show that, after reaching the maximum, the quantity of electric charge gradually and slightly decreases. It is presumed that the quantum wells may become shallow and the number of the quantum wells may decrease. That is, the crosslinked part or the crystallized part of the sheet-shaped member may be discomposed by electrons in the quantum wells, so that the electric charge retention properties become inferior.

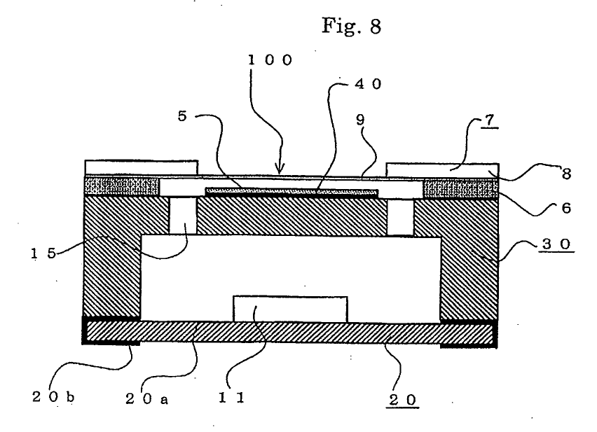

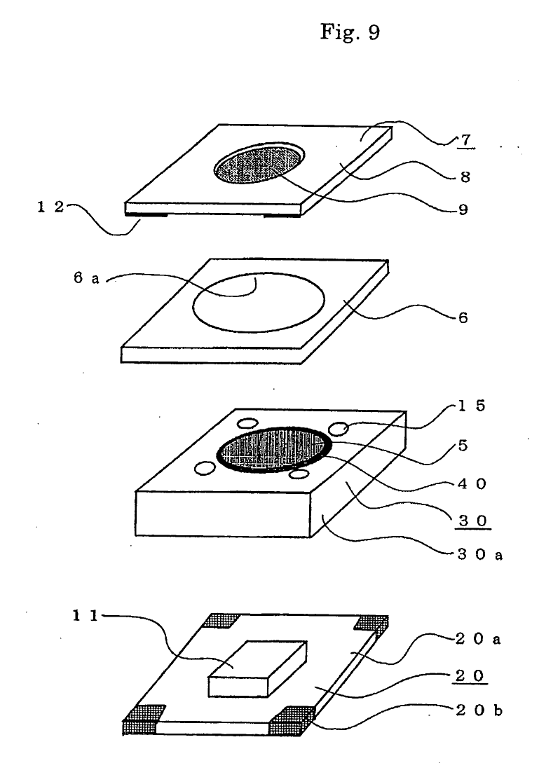

FIGS. 8 and 9 show an electret condenser microphone, which is a typical product using the heat-resistant electrically charged resin material according to the present invention as an electret layer.

In FIG. 8, a circuit board 20 comprises an insulating substrate 20a on which connecting terminals 20b are formed. In addition, an integrated circuit 11, which is an electronic component, is mounted on the insulating substrate 20a. An insulating backplate substrate 30 is mounted on the circuit board 20 such that the insulating backplate substrate 30 accommodates the integrated circuit 11 in a recess formed therein. A backplate electrode 40 is formed on the upper flat surface of the insulating backplate substrate 30. An electret layer 5 is formed on the backplate electrode 40. A plurality of holes 15 are formed through the insulating backplate substrate 30. A spacer 6 has an opening 6a. A diaphragm unit 7 has an annular diaphragm support frame 8 formed from an insulating material. The diaphragm support frame 8 is provided with diaphragm electrodes 9. An electrically conductive diaphragm 10 is opposed and connected to the underside of the diaphragm support frame 8 with the diaphragm electrodes 9 are interposed therebetween.

Specifically, the backplate substrate 30 has a backplate electrode 40 formed on the upper side thereof. A sheet-shaped member with a thickness of 12.5 μm or 25 μm made of FEP, which is a fluorine-containing resin material, is thermocompression-bonded to the upper side of the backplate electrode 40 through an adhesive 3 at a temperature of about 150° C. The sheet-shaped member is then heated at a temperature 280° C. to 330° C., which is not lower than the crystalline melting point of FEP, in the presence of oxygen, that is, in the air for about 5 minutes. The adhesive 3 is thus melted and oxidized so that the adhesive 3 is set.

Further, the backplate substrate 30 is placed in ionizing radiation irradiation equipment. In the ionizing radiation irradiation equipment, the backplate substrate 30 is irradiated with ionizing radiation at a dose of about 10 kGy to 100 kGy with an electric beam intensity of 500 keV to 800 keV in an atmosphere of about 300° C., which is not lower than the crystalline melting point of the FEP, in the absence of oxygen, i.e. at an oxygen concentration not higher than 50 ppm (step J2 in FIG. 1), thereby changing the FEP into a crosslinked modified heat-resistant fluororesin.

Further, the backplate substrate 30 is placed in electrical charge implantation equipment to implant an electric charge into the modified fluororesin (step J3 in FIG. 1), thereby completing a heat-resistant electrical charged fluororesin material which serves as an electret layer 5.

The above-described constituent elements, i.e. the circuit board 20, the backplate substrate 30, the spacer 6 and the diaphragm unit 7, are stacked with an adhesive interposed between each pair of adjacent elements, as shown in FIG. 9, thereby completing an ECM 100.

To mount the completed ECM 100 onto a motherboard of a portable cellular phone or other device, the output terminals 20b of the ECM 100 are placed on the motherboard and preheated in a reflow oven at about 150° C. to 200° C. for about 90 seconds to 120 seconds, followed by high-temperature processing at a temperature not lower than 230° C. for about 10 seconds. Despite the high-temperature processing, there is a minimal discharge of the electric charge implanted in the electric layer 5 or the above-described heat-resistant electrically charged resin material, as will be stated later, Accordingly, the ECM 100 can function as desired without any problem.

In the ECM 100 having the above-described structure, the diaphragm 9 having an electrically conductive film on the surface thereof and the backplate electrode 40 having the electret layer 5 formed on the surface thereof are opposed each other with the spacer 6 interposed therebetween to form a capacitor. When the diaphragm 9 is vibrated by sound or the like, the capacitance of the capacitor changes, and the change in capacitance is taken out to the circuit board 20 from the diaphragm terminals 12 as a change in voltage. After being processed in the integrated circuit 11, the voltage signal is output from the output terminals 20b of the circuit board 20. The holes 15 are provided to smooth the movement of the diaphragm 10, which causes good sound.

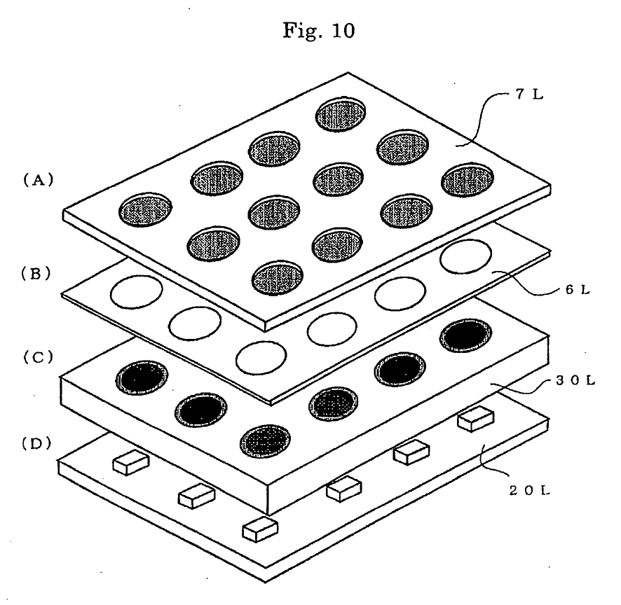

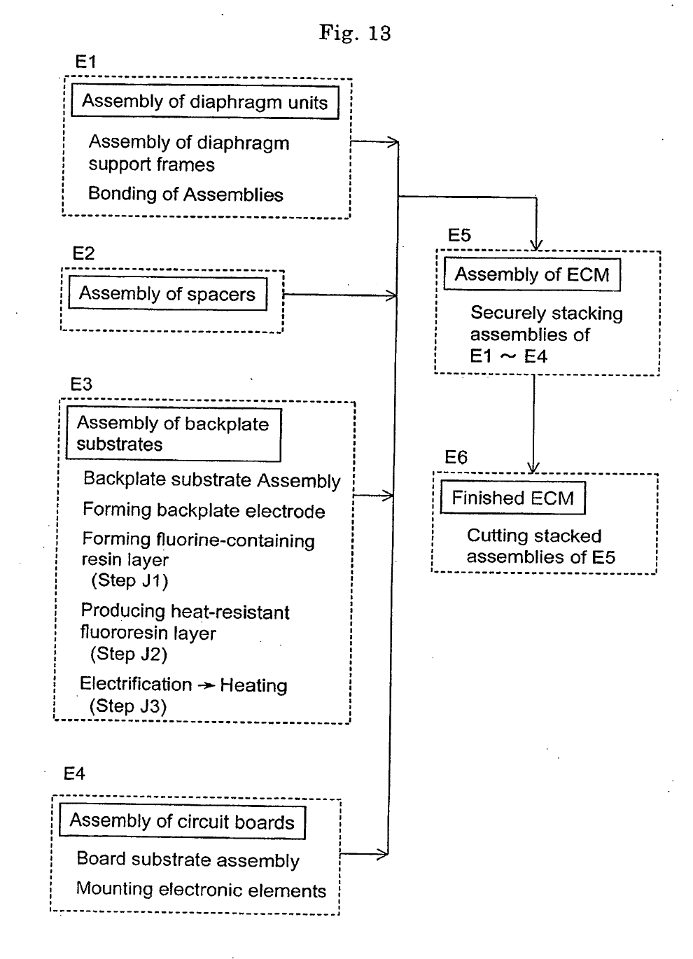

FIGS. 10 to 12 show the most productive method of producing the above-described ECM 100.

FIG. 10 is a perspective view of constituent elements used in an electret microphone producing method according to the present invention. As shown, a diaphragm unit assembly 7L is an assembly of diaphragm units 7 as shown in FIG. 9 arrayed in a matrix, having diaphragm electrodes 9 on the lower side thereof. Similarly, a spacer assembly 6L is an assembly of spacer 6 as shown in FIG. 9 arrayed in a matrix.

Further, a backplate substrate assembly 30L is an assembly of backplate substrates 30 as shown in FIG. 9 arrayed in a matrix, placing many backplate electrodes 40 and electret layers 5 on the upper side thereof. In manufacturing an electret layer 5, step J1 to J3 are taken in the state of a backplate substrate assembly 30L. A circuit board assembly 20L is an assembly of circuit boards 20 as shown in FIG. 9 arrayed in a matrix. Each above-described assembly has terminal patterns, vias and so on.

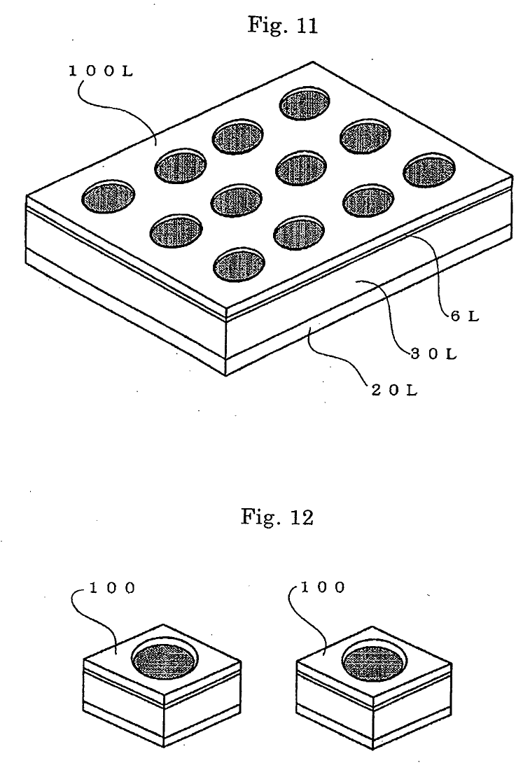

FIG. 11 shows a microphone assembly 100L obtained by stacking and bonding the above-described assemblies. The microphone assembly 100L has a multiplicity (12 ECM in the illustrated example) of ECM 100 each comprising a stack of one diaphragm unit of the diaphragm unit assembly 7L, one spacer of the spacer assembly 6L, one backplate substrate of the backplate substrate assembly 30L and one circuit board of the circuit board assembly 20L. In the microphone assembly 100L, each electret condenser microphone 100 has the integrated circuit 11, the backplate 4, the electret layer 5, the spacer opening 6a and a diaphragm 10, which are aligned on the same axis. The microphone assembly 100L is cut with a cutter, thereby producing individual divided ECM 100.

FIGS. 10 to 12 show a microphone assembly having 12 ECMs arrayed in a matrix of 3 rows and 4 columns for the sake of explanation. Actually, however, the microphone assembly is prepared as including several hundreds of ECMs.

FIG. 13 is a process flow chart showing the steps of a method of producing electret condenser microphones in the way as stated above.

In step E1, the diaphragm unit assembly 7L is prepared as an assembly of diaphragm units by connecting an electrically conductive diaphragm to one side of the assembly of diaphragm support frames 8 with the terminals 12 interposed therebetween.

In step E2, the spacer assembly 6L is prepared by forming a plurality of openings 6a in a plate-shaped spacer material.

In step E3, the backplate substrate assembly 30L is prepared wherein a plurality of backplate substrates and a plurality of sheets of FEP with acrylic adhesive are laminated on a backplate substrate assembly comprising an insulating substrate to form the backplate substrate assembly 30L. After the process of heating and EB treatment, in the ionizing radiation irradiation equipment, the backplate substrate assembly 30L is irradiated with about 10 kGy to 100 kGy of ionizing radiation in an atmosphere of 300° C., which is not lower than the crystalline melting point of the FEP, in absence of oxygen, i.e. at an oxygen concentration not higher than 100 ppm, thereby changing the FEP with the adhesive into a crosslinked heat-resistant fluororesin.

Next, the backplate substrate assembly is loaded into the electric charge implantation equipment to implant an electric charge into the electret layer of the modified FEP with the adhesive, thereby completing a heat-resistant backplate substrate assembly 30L.

In step E4, the circuit board assembly 20L is formed by mounting electronic elements such as integrated circuits 11 on a wiring board assembly as an assembly of circuit boards 20 each having the connecting terminals, circuit patterns and so on.

In step E5, the above-stated assemblies are stacked and bonded to each other, thereby completing a electret condenser microphones 100L.

In step E6, the microphone assembly 100L is cut with a cutter, thereby producing individual divided ECMs 100.

As has been stated above, the heat resistant electrically charged fluororesin material according to the present invention exhibits a minimal reduction in the implanted electric charge under high-temperature conditions and is therefore suitable for use as an electret layer of an ECM that undergoes high-temperature mounting process e.g. reflow process. However, as stated above, even if an fluorine-containing resin material is not adhered to a substrate, the material which has been subject to the EB treatment and the following electrifying treatment exhibits a good electric charge retention properties as compared with the material which has not been subject to the EB treatment and, therefore, the material or heat resistant electrically charged fluororesin material is applicable to other various uses. For example, it is possible to produce a filter suitable for an air conditioner that is used under high-temperature conditions. The filter may be a nonwoven fabric filter, as it has been proved that the nonwoven fabric filter exhibits a strong power of absorbing fine particles in air and exhaust gas. Further, it will be therefore possible to produce a dust-proof mask, a mask for pollinosis, etc.

It should be noted that the present invention is not necessarily limited to the foregoing embodiments but can be modified in a variety of ways without departing from the gist of the present invention. For example, materials to be processed through the method of the present invention can be of any shape other than “sheet”. In connection with this, it should be noted that the term “sheet-shaped member” used in this specification includes members in the shapes of a film, a web, a fabric or the like.

What is claimed:

1. A method of producing a heat-resistant electrically charged fluororesin material, comprising the steps of:
providing a fluorine-containing resin material;
forming an adhesive layer on a side of said material;
irradiating said fluorine-containing resin material with ionizing radiation at a temperature not lower than a crystalline melting point of said fluorine-containing resin material in absence of oxygen, thereby causing crosslinking in said fluorine-containing resin material to change said fluorine-containing resin material into a heat-resistant fluororesin material; and,
electrifying said heat-resistant fluororesin material to form a heat-resistant electrically charged fluororesin material;
wherein said adhesive layer acts on the fluorine-containing resin material to maintain the shape of said material during the steps of irradiating and electrifying.

2. The method of claim 1, further comprising the step of heating said fluorine-containing resin material with said adhesive layer at a temperature not lower than a crystalline melting point of said fluorine-containing resin material in presence of oxygen before said step of irradiating.;

3. The method of claim 1, wherein before said step of heating, said fluorine-containing resin material is adhered to a substrate though said adhesive layer.

4. The method of claim 2, wherein said substrate is one selected from a group consisting of a metal substrate, a resin substrate, and a ceramic substrate.

5. The method of claim 4, wherein said step of heating is performed at a temperature of 260° C. to 330° C. in the air.

6. The method of claim 5, wherein in said step of irradiating, said fluorine-containing material is irradiated with ionizing radiation at a dose of 10 kGy to 100 kGy, at a temperature of 260° C. to 330° C., and at an oxygen concentration not higher than 50 ppm.

7. The method of claim 6, wherein said adhesive layer is made of one of an acrylic adhesive, a silicon adhesive, acrylic pressure-sensitive adhesive and a silicone pressure-sensitive adhesive.

8. The method of claim 6, wherein said fluorine-containing resin material is one selected from the group consisting of polytetrafluoroethylene, tetrafluoroethylene-hexafluoropropylene-copolymer, and tetrafluoroethylene-perfluoroalkyl-vinyl-ether-copolymer.

9. The method of claim 1, wherein said method further comprises a step of heating said heat-resistant fluororesin material following said step of electrifying;
wherein said successive steps of electrifying and heating are repeatedly effected more than one time.

10. The method of claim 1, wherein said fluorine-containing resin material is in the shape of a sheet.

11. The method of claim 1, wherein said heat-resistant electrically charged fluororesin material is negatively electrified.

12. A method of producing a heat-resistant electrically charged fluororesin material, comprising the steps of:
providing a fluorine-containing resin material;
irradiating said fluorine-containing resin material with ionizing radiation at a temperature not lower than a crystalline melting point of said fluorine-containing resin material in absence of oxygen, thereby causing crosslinking in said fluorine-containing resin material to change said fluorine-containing resin material into a heat-resistant fluororesin material;
electrifying said heat-resistant fluororesin material; and
heating said heat-resistant fluororesin material following said step of electrifying;
wherein said successive steps of electrifying and heating are repeatedly effected more than one time.

13. The method of claim 12, wherein said fluorine-containing resin material is in the shape of a sheet.

14. The method of claim 13, wherein said heat-resistant electrically charged fluororesin material is negatively electrified.

15. The method of claim 12, wherein
said step of electrifying is performed by a corona discharge of a voltage of −500 V +/−200 V at an ambient temperature in the air; and,
said step of heating said heat-resistant fluororesin material is performed at a temperature of 260° C. to 330° C.

16. The method of claim 12, wherein in said step of irradiating, said fluorine-containing material is irradiated with ionizing radiation at a dose of 10 kGy to 100 kGy, at a temperature of 260° C. to 330° C., and at an oxygen concentration not higher than 50 ppm.

17. An electret condenser microphone comprising a diaphragm and an electret layer opposed to said diaphragm;
wherein said electret layer is made of a heat-resistant electrically charged fluororesin material produced by the method of claim 13.

18. A method of producing an electret condenser microphone comprising a diaphragm and an electret layer formed on a backplate substrate;
preparing a backplate substrate having a flat surface;
preparing a sheet-shaped member of fluorine-containing resin material having opposite sides;
forming an adhesive layer on one of said opposite sides of said sheet-shaped member;
adhering said sheet-shaped member onto said flat surface of said backplate substrate through said adhesive layer;
irradiating said fluorine-containing resin material with ionizing radiation at a temperature not lower than a crystalline melting point of said fluorine-containing resin material, thereby causing crosslinking in said fluorine-containing resin material to change said fluorine-containing resin material into a heat-resistant fluororesin material; and,
electrifying said heat-resistant fluororesin material to change said heat-resistant fluororesin material into an electret layer on said backplate substrate
wherein said adhesive layer acts on said sheet-shaped member to maintain the shape of said sheet-shaped member during the steps of irradiating and electrifying.

19. The method of claim 18, further comprising the step of heating said fluorine-containing resin material with said adhesive layer at a temperature not lower than a crystalline melting point of said fluorine-containing resin material in presence of oxygen before said step of irradiating.

20. A method of producing electret condenser microphones each comprising a diaphragm, an electret layer formed on a backplate substrate, a spacer interposed between the diaphragm and the electret layer, and electronic circuit board on which the backplate substrate is disposed, said method comprising the steps of:
providing an electronic circuit board assembly in which a multiplicity of electronic circuit boards comprising electronic elements mounted thereon are arrayed in a matrix;
providing a backplate substrate assembly in which a multiplicity of backplate substrates each having a flat surface are arrayed in a matrix;
providing sheet-shaped members of fluorine-containing resin material, each of said sheet-shaped members having opposite sides;
providing a spacer assembly in which a multiplicity of spacers are arranged in a matrix;
providing a diaphragm assembly in which a multiplicity of diaphragm units are arrayed in a matrix;
forming an adhesive layer on one side of each sheet-shaped member;
adhering said sheet-shaped members onto said flat surfaces of said backplate substrates through said adhesive layers, respectively;
irradiating said sheet-shaped members on said backplate substrates with ionizing radiation at a temperature not lower than a crystalline melting point of said fluorine-containing resin material, thereby causing crosslinking in said fluorine-containing resin material to change said fluorine-containing resin material into a heat-resistant fluororesin material; and,
electrifying said sheet-shaped members to change them into electret layers;
securely stacking said electronic circuit board assembly, said backplate substrate assembly, said spacer assembly and said diaphragm assembly to form a stacked assembly; and
cutting said stacked assembly into individual electret condenser microphones;
wherein said adhesive layers act on said sheet-shaped members to maintain the shape of said sheet-shaped members during the steps of irradiating and electrifying.

21. The method of claim 20, further comprising the step of heating said fluorine-containing resin material with said adhesive layer at a temperature not lower than a crystalline melting point of said fluorine-containing resin material in presence of oxygen before said step of irradiating.

22. A method of producing electret condenser microphones each comprising a diaphragm, an electret layer formed on a backplate substrate, a spacer interposed between the diaphragm and the electret layer surrounding the electret layer, and electronic circuit board on which the backplate substrate is disposed, said method comprising the steps of:
providing an electronic circuit board assembly in which a multiplicity of electronic circuit boards comprising electronic elements mounted thereon are arrayed in a matrix;
providing a backplate substrate assembly in which a multiplicity of backplate substrates each having a flat surface are arrayed in a matrix;
providing a sheet-shaped member of fluorine-containing resin material having an adhesive layer provided on one side of the sheet-shaped member;
providing a spacer assembly in which a multiplicity of spacers are arranged in a matrix;
providing a diaphragm assembly in which a multiplicity of diaphragm units are arrayed in a matrix;
irradiating said sheet-shaped member with ionizing radiation in absence of oxygen at a temperature not lower than a crystalline melting point of said fluorine-containing resin material, thereby causing crosslinking in said fluorine-containing resin material to change said fluorine-containing resin material to heat-resistant fluororesin material;
stamping said sheet-shaped member to form a multiplicity of pieces of said sheet-shaped member with pieces of said adhesive layer;
securely attaching said pieces of said sheet-shaped member to said flat surfaces of said backplate substrates through said pieces of said adhesive layer, respectively;
electrifying said pieces of said sheet-shaped member to change them to electret layers on said backplate substrates;
securely stacking said electronic circuit board assembly, said backplate substrate assembly, said spacer assembly and said diaphragm assembly to form a stacked assembly; and
cutting said stacked assembly into individual electret condenser microphones:
wherein said pieces of said adhesive layer act on said pieces of said sheet-shaped members to maintain the shape of said pieces of said sheet shaped members during the steps of irradiating and electrifying.

23. The method of claim 22, wherein said method further comprises the steps of:
heating said sheet-shaped member in presence of oxygen at a temperature not lower than a crystalline melting point of said fluorine-containing resin material before the step of irradiating said sheet-shaped member; and,
heating said pieces of said sheet-shaped members succeeding to said step of electrifying;
wherein said successive steps of irradiating and heating said sheet-shaped member are repeatedly effected more than one time.

24. A method of producing an electret condenser microphone comprising a diaphragm and an electret layer formed on a backplate substrate; said method comprising the steps of:
providing a backplate substrate having a flat surface;
providing a sheet-shaped member of fluorine-containing resin material;
securely disposing said sheet-shaped member on said flat surface of said backplate substrate;
irradiating said sheet-shaped member on said flat surface of said backplate substrate with ionizing radiation at a temperature not lower than a crystalline melting point of said fluorine-containing resin material in absence of oxygen, thereby causing crosslinking of said fluorine-containing resin material to change said fluorine-containing resin material into a heat-resistant fluororesin material;
electrifying said heat-resistant fluororesin material; and
heating said sheet-shaped member following said step of electrifying;
wherein said successive steps of electrifying and heating are repeatedly effected more than one time to change said sheet-shaped member into an electret layer on said backplate.

25. A method of producing electret condenser microphones each comprising a diaphragm, an electret layer formed on a backplate substrate, a spacer interposed between the diaphragm and the electret layer, and electronic circuit board on which the backplate substrate is disposed, said method comprising the steps of:
providing an electronic circuit board assembly in which a multiplicity of electronic circuit boards comprising electronic elements mounted thereon are arrayed in a matrix;
providing a backplate substrate assembly in which a multiplicity of backplate substrates each having a flat surface are arrayed in a matrix;
providing sheet-shaped members of fluorine-containing resin material, each sheet-shaped member having opposite sides;
providing a spacer assembly in which a multiplicity of spacers are arranged in a matrix;
providing a diaphragm assembly in which a multiplicity of diaphragm units are arrayed in a matrix;
securely disposing said sheet-shaped member on said flat surfaces of said backplate substrates, respectively;
irradiating said sheet-shaped members on said flat surfaces of said backplate substrates with ionizing radiation at a temperature not lower than a crystalline melting point of said fluorine-containing resin material, thereby causing crosslinking in said fluorine-containing resin material to change said fluorine-containing resin material to heat-resistant fluororesin material; and,
electrifying and successively heating said sheet-shaped members after said step of irradiating more than one time to form an electret on each of said flat surfaces of said backplate substrates;
securely stacking said electronic circuit board assembly, said backplate substrate assembly, said spacer assembly and said diaphragm assembly to form a stacked assembly; and
cutting said stacked assembly into individual electret condenser microphones.
